(19) United States
(12) Patent Application Publication
(10) Pub. No.: US 2006/0136981 A1
(43) Pub. Date: Jun. 22, 2006

(54) Transport stream demultiplexor with content indexing capability

(76) Inventor: Dmitrii Loukianov, Chandler, AZ (US)

Correspondence Address: BUCKLEY, MASCHOFF, TALWALKAR LLC, 5 ELM STREET, NEW CANAAN, CT, 06840, US

(21) Appl. No.: 11/018,913

(22) Filed: Dec. 21, 2004

(51) Int. Cl. H04B 1/66; H04N 11/04; H04N 7/16; H04N 7/173; H04N 7/12; H04N 11/02

(52) U.S. Cl. 725/135; 725/90; 375/240.2

(57) ABSTRACT

According to some embodiments, a multi-media Transport Stream (TS) that encapsulates at least one Packetized Elementary Stream (PES) is received, and an Elementary Stream (ES) is encapsulated in the PES. An event occurring in the ES may be detected while the ES is encapsulated in the PES, and event information associated with the event may be stored in an index.

### BACKGROUND

A media player may receive a stream of multi-media information from a media server. For example, a content provider might deliver a stream that includes high-definition audio/video program to a television, a set-top box, or a digital video recorder through a cable or satellite network in a multiplexed, multi-program stream optimized for the transport media used for broadcasting. It may be convenient to navigate through this program, especially in a time-shifted viewing or recording or playback mode. The navigation may be based on an index data extracted from the audio/video program itself, from ancillary data streams or from attributes associated with the transmitted data due to the nature of digital transmission. Moreover, it might be desirable to determine a location in the stream or time associated with events in the program or in ancillary data streams that can be used later for navigation. For example, the location or time associated with an encryption key stored in the stream might be needed to facilitate a reverse playback of multi-media information to a viewer. As another example, pictures and group of pictures markers may be detected in the video stream to facilitate the seek operations. Note that indexing information may be hidden deep in several layers of data encapsulation in typical video system, and usually full demultiplexing and separation of the elementary data stream is required for indexing.

### BRIEF DESCRIPTION OF THE DRAWINGS

FIG. 1 is a block diagram of a media system.

FIG. 2 illustrates the structure of an elementary stream of multi-media information.

FIG. 3 illustrates the structure of a packetized elementary stream of multi-media information.

FIG. 4 illustrates the structure of a transport stream of multi-media information.

FIG. 5 is a block diagram of a media system according to some embodiments.

FIG. 6 is a flow chart illustrating a method of detecting an event according to some embodiments.

FIG. 7 is a tabular representation of a portion of an index according to some embodiments.

FIG. 8 is a flow chart illustrating a method of using event information according to some embodiments.

FIG. 9 is a block diagram of a personal video recorder according to some embodiments.

FIG. 10 illustrates event detection states according to some embodiments.

FIG. 11 illustrates event detection states and a stored context according to some embodiments.

FIG. 12 is a block diagram of a system according to some embodiments.

### DETAILED DESCRIPTION

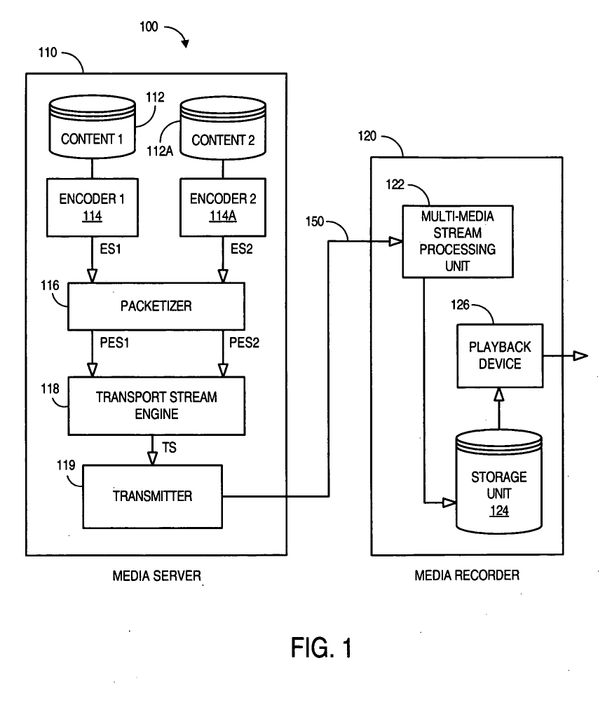

A media device may receive multi-media content, such as a television program, from a content provider. For example, FIG. 1 is a block diagram of a media system 100 in which a media server 110 transmits a multi-media information stream to a media recorder 120. The media recorder 120 might comprise or be associated with, for example, a television, a Personal Computer (PC), a game device, a digital video recorder, and/or a set-top box. The media information stream might be delivered, for example, through a network 150 (e.g., a cable or satellite television network) or other digital transport.

To efficiently deliver digital media content through the network 150, the media server 110 may encode information in accordance with an image processing process, such as a Motion Picture Experts Group (MPEG) process as defined by International Organization for Standardization (ISO)/International Engineering Consortium (IEC) document number 11172-1 entitled “Information Technology—Coding of Moving Pictures and Associated Audio for Digital Storage Media” (1993). Similarly, a High Definition Television (HDTV) stream might be encoded in accordance with the MPEG4 process as defined by ISO/IEC document number 14496-1 entitled “Information Technology—Coding of Audio-Visual Objects” (2001). As still another example, a stream might be encoded in accordance with the MPEG2 process as defined by ISO/IEC document number 13818-1 entitled “Information Technology—Generic Coding of Moving Pictures and Associated Audio Information” (2000).

The media server 110 may include a first encoder 114 that retrieves original image content from a first storage device 112 and generates a first Elementary Stream (ES1) of encoded multi-media image information. In some cases, multiple channels of media content are delivered concurrently in time-multiplexed packetized manner through the network 150. To accomplish that, the media server 110 may also include a second encoder 114A that retrieves original image content from a second storage device 112a and generates ES2. Although two encoders 114, 114A are illustrate in FIG. 1, the media system 100 may include any number of encoders.

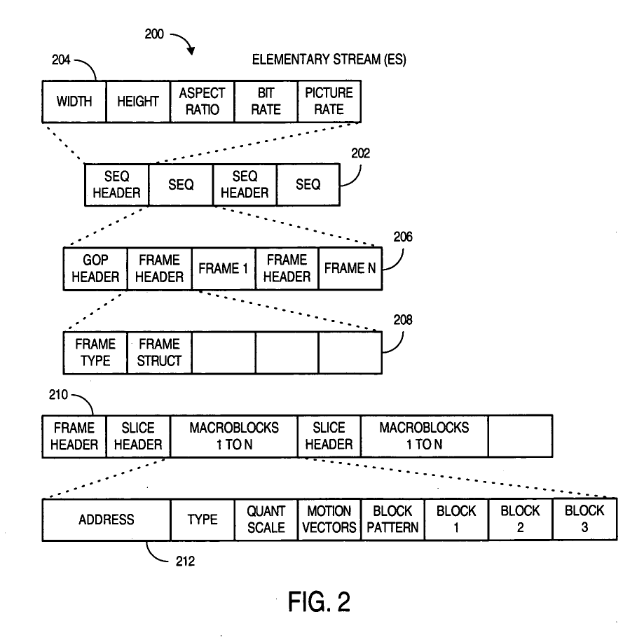

FIG. 2 illustrates the structure of an ES 200. The ES 200 might include fields 202 that include sequence headers 204 (e.g., describing an image width, height, aspect ratio, bit rate, and/or picture rate) and associated picture, audio or descriptor sequences 206. Each sequence 206 might include, for example, a Group Of Pictures (GOP) header, image frames (e.g., I, B, or P frames), and associated frame headers 208 (e.g., describing a frame type and/or structure). Moreover, the ES 200 may include data fields 210 with frame headers, slice headers, and sets of macroblocks 212 (e.g., including address information, macroblock type information, quantizer scale information, motion vectors, coded block patterns, and blocks of image information).

Referring again to FIG. 1, a packetizer 116 at the media server 110 might receive ES1 and “encapsulate” the stream in a first Packetized Elementary Stream PES1. That is, the information in ES1 may be packetized and encapsulated with packet header information to create PES1. Similarly, the packetizer 116 may receive ES2 and encapsulate that stream in PES2.

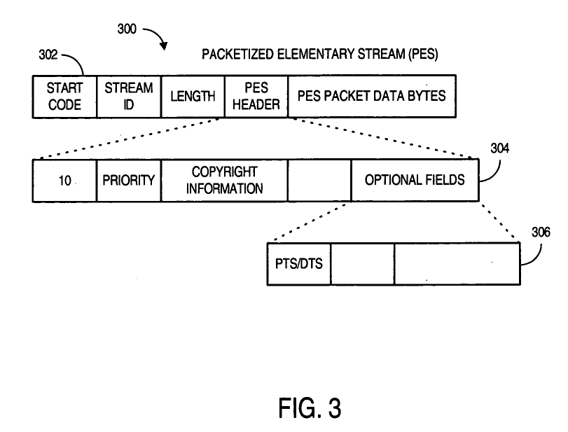

FIG. 3 illustrates the structure of a PES 300 of multi-media information. The PES 300 may include data fields 302 that include a start code, a stream identifier, length information, a PES header 304, and associated PES packet data bytes. The PES packet data bytes might carry, for example, 64 kilobytes of ES data payload. The PES header 304 might include, for example, priority information, copyright information, and other information, such as a Presentation Time Stamp (PTS) and/or Decode Time Stamp (DTS) 306.

Referring again to FIG. 1, a transport stream engine 118 might receive PES1 and PES2. The transport stream engine 118 may multiplex PES1 and PES2 and encapsulate the information with header information to create a Transport Stream (TS). Although in MPEG video architecture the transport stream is defined by IEC 13818-1 standard, as used herein the terms “ES,” “PES,” and “TS” may refer to an encapsulation of data in other ways for the purpose of transporting the data over digital communication networks, such as encapsulation into Asynchronous Transfer Mode (ATM) or Internet Protocol (IP) packets.

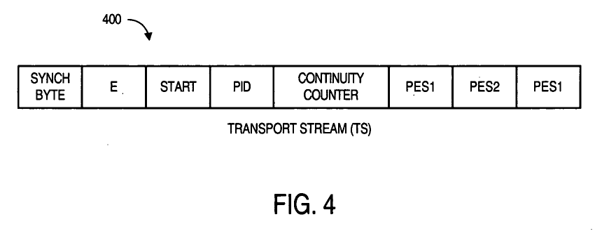

FIG. 4 illustrates a TS 400 of multi-media information. The TS 400 may include, for example, a synchronization byte, error information (E), a payload unit start indicator, a Packet Identifier (PID), continuity information, and multiplexed PES information. Note that the payload of the TS may include discontinuous portions from PES1, PES2 (and thus ES1, ES2) and ancillary data. Referring again to FIG. 1, a transmitter 119 may deliver the TS to the media recorder 120 via the network 150.

The media recorder 120 may receive the TS and process the image information with a multi-media stream processing unit 122. Moreover, multi-media information might be recorded in a storage unit 124 (e.g., a memory or hard disk drive). A playback device 126 may access recorded multi-media information from the storage unit 124 to generate an output signal (e.g., to be provided to a video display and/or speakers).

In some cases, the media recorder 120 may need to determine a location or time associated with an event that has occurred in the ES, PES, and/or TS. For example, the location or time associated with the desired new GOP may need to be determined when a viewer wants to skip 30 seconds of a program. Note that a substantial amount of multi-media information may be recorded in the storage unit 124 (e.g., a recorded block might include several gigabytes of data). As a result, searching through the information to determine the location in the recorded data stream associated with a desired event may be impractical.

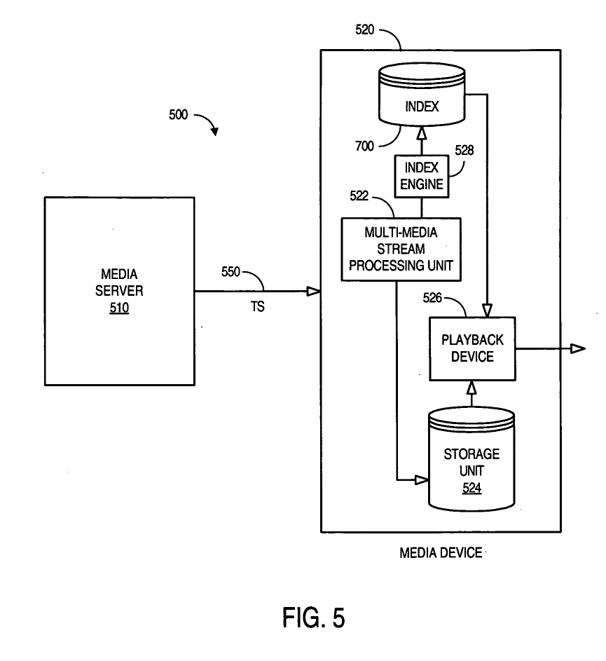

FIG. 5 is a block diagram of a media system 500 according to some embodiments. In particular, a media server 510 delivers a TS to a media device 520 through a network 550. The media device 520 may be associated with, for example, a video display device, a television, a Personal Video Recorder (PVR), a game device, a PC, or a set-top box. The network 550 might be associated with, for example, a cable-based communication network, a satellite communication network, an over-the-air television broadcast, a packet-based network, an Internet protocol network, or an Asynchronous Transfer Mode (ATM) network.

As before, a multi-media stream processing unit 522 processes and records multi-media information in a storage unit 524, and a playback device 526 may access the recorded multi-media information and generate an output signal (e.g., when playing recorded data for a user). To reduce the amount of the recorded data and increase the maximum recording capacity, the multi-media stream processing unit 522 may extract the transport packets that belong to the program of interest and ignore (remove) all packets that are irrelevant to selected program. This operation may be done at the transport packet level, without actually demultiplexing or interpreting the program's data.

According to some embodiments, an index engine 528 is provided to detect events occurring in the ES while the ES is still encapsulated in the PES, and PES is still encapsulated in TS packets, without explicit demultiplexing the program. For example, the index engine may detect events as the multi-media information is being recorded. Moreover, the index engine 528 may store event information in an index storage or file 700. The playback device 526 may then use the stored event information to quickly access the required areas in the recorded stream and facilitate a later presentation of recorded multi-media content to a viewer. As a result, a TS demultiplexor with context indexing may detect, for example, pictures and/or GOP markers for multiple concurrent independent programs without a complete demultiplexing of elementary streams.

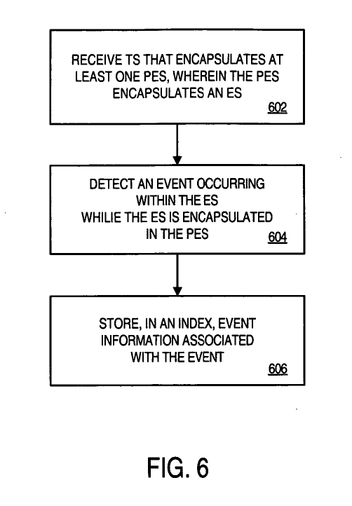

FIG. 6 is a flow chart illustrating a method of detecting an event according to some embodiments. The method may be performed, for example, by the media device 520 of FIG. 5. The flow charts described herein do not necessarily imply a fixed order to the actions, and embodiments may be performed in any order that is practicable. Note that any of the methods described herein may be performed by hardware, software (including microcode), firmware, or any combination of these approaches. For example, a storage medium may store thereon instructions that when executed by a machine result in performance according to any of the embodiments described herein.

At 602, a multi-media TS that encapsulates at least one PES is received, wherein the PES encapsulates at least one ES. For example, the TS might be delivered from a content provider to a media device through a network.

At 604, an event occurring within the ES is detected while the ES is encapsulated in the PES. The event might be detected, for example, by a hardware index engine. According to some embodiments, the index engine may be implemented using a programmable processor and associated firmware. Note that the event may be detected in parallel with an extraction of the ES from the PES. Moreover, the event may be detected using a first copy of the PES or TS after the ES has already been extracted from another copy of the PES or TS.

The event detected in the ES might, for example, be associated with a change in an image processing process or flow. For example, the event information might include an image processing process identifier, a GOP, or a GOP header. Other examples of events in the ES include, a frame, a frame type, a frame header, a sequence, a sequence header, a slice, a slice header, a quantizer scale, a motion vector, a start of block, a picture width, a picture height, an aspect ratio, a bit rate, a picture rate, a bit pattern, a start bit pattern, and/or picture entropy parameters.

The ES event might also be associated with an encryption status change. For example, the event might indicate that an encryption protocol identifier or a decryption key has been detected.

According to some embodiments, the event may be associated with media content. In this case, the event might indicate that the ES includes a server identifier, a media content identifier, media content rating information, a program identifier, a program title, a program description, or program schedule information.

According to still other embodiments, the ES event is associated with viewer information. For example, the event might be associated with a viewer flag (e.g., a viewer might activate a button on a remote control to “bookmark” media content), a viewer preference, a viewer rule, or a viewer identifier.

A media device might, according to some embodiments, analyze information within the ES (while the ES is encapsulated in the PES) to infer the occurrence of an event. For example, heuristics might be applied to information associated with at least one motion vector or quantization coefficient to infer a scene change, a scene context, or a scene type.

The event is detected at 604 while the ES is still encapsulated in the PES. According to some embodiments, the event may be detected while the PES is still encapsulated in the TS. Moreover, according to some embodiments an event may be detected as the combined event on multiple levels on the PES or ES levels. Examples of such events might include a DTS, a PTS, a stream identifier, a packet length, a PES header, or copyright information.

Similarly, according to some embodiments an event may be detected in the TS (instead of, or in addition to, the PES and/or ES). Examples of this type of event might include a programme clock reference, error information, a packet identifier, scrambling information, discontinuity information, priority information, splice information, or payload unit start information.

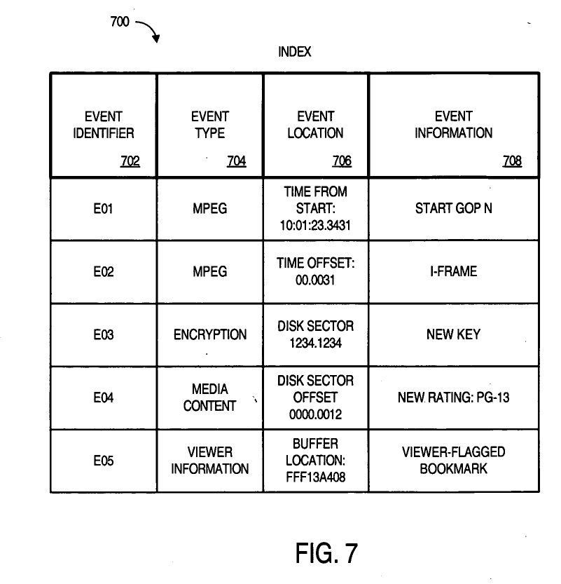

At 606, event information associated with the event is stored in an index storage. The index may be, for example, stored in a memory unit or a disk storage unit. FIG. 7 is a tabular representation of a portion of an index 700 according to some embodiments. The illustration and accompanying description of the index 700 presented herein is exemplary, and any number of other arrangements could be employed besides those suggested by the figure.

The table includes entries identifying events that have been detected. The table also defines fields 702, 704, 706, 708 for each of the entries. The fields specify: an event identifier 702, an event type 704, an event location 706, and event information 708. The information in the index 700 may be created and updated, for example, by the index engine 528 of FIG. 5.

The event identifier 702 may be, for example, an alphanumeric code associated with an event that has been detected in the ES. They event type 704 might indicate a type of event that has been detected (e.g., a change in image processing or flow, an encryption-related event, or an event indicating a change in media content).

The event location 706 specifies the position where the event occurred within the ES. The event location 706 might be, for example, a time from a start of a recorded block or a time offset (e.g., from the last event). According to another embodiment, the event location 706 is a disk file pointer or offset. Similarly, an event memory location or location offset might define the location of an event (e.g., within a memory buffer).

The event information 708 might provide further information about the event that was detected. For example, the event information 708 might indicate which ES parameter was detected, that a new decryption key was received, or that a rating of a program has changed. Note that when the index 700 stores information about only one type of event, the event type 704 and event information 708 may not be required.

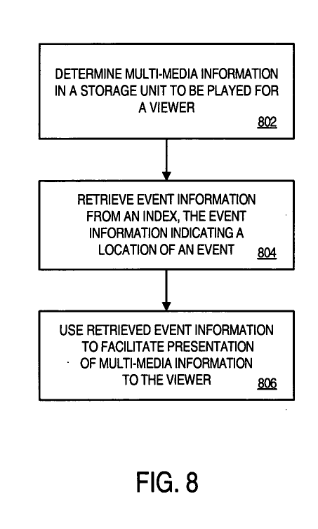

FIG. 8 is a flow chart illustrating a method of using event information (e.g., from the index 700) according to some embodiments. At 802, multi-media information to be provided to a viewer is determined. For example, recorded multi-media information may be selected by a viewer and/or retrieved from the storage unit 524 of the media device 520.

At 804, event information is retrieved from the index 700, and the retrieved information is used to facilitate a presentation of the recorded multi-media information to the viewer at 806.

Consider, for example, an index that stores memory locations associated with GOP starts in the ES. When a user instructs the player to seek to a new portion of a program (e.g., by skipping ahead five minutes), a memory location containing an appropriate start of GOP might be retrieved from the index and used to quickly and efficiently construct an image to be provided the viewer.

As another example, an index might store time values associated with encryption information. For example, different decryption keys might be required to decrypt different portions of a program. In this case, when a viewer instructs the player to seek to a different portion of a program (e.g., by rewinding thirty seconds), a time value associated with the appropriate decryption key might be retrieved from the index, and the time value may be used to quickly find the key required to descramble the content.

As another example, an index may store information associated with the media content of an ES along with viewer-introduced index information. For example, a viewer might flag a portion of a multi-media program, and a disk location associated with the nearest start of GOP for that portion might be stored in the index. When the viewer wants to return to the flagged portion, the information in the index may be retrieved and used for that purpose.

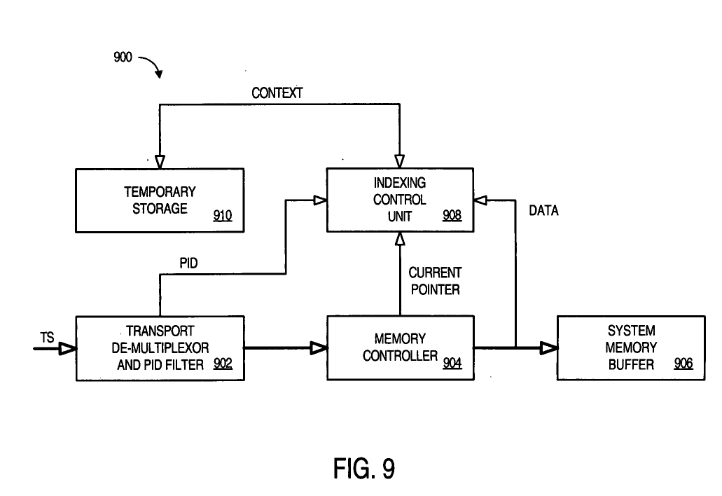

FIG. 9 is a block diagram of a PVR 900 according to some embodiments. In particular, the PVR 900 includes a transport de-multiplexer and PID filter 902 that receives a TS (e.g., delivered by a content provider through a network). The de-multiplexer 902 may provide transport packets to a memory controller 904, which in turn passes the packets to a system memory buffer 906 (to eventually be recorded and/or used to generate a multi-media presentation for a viewer).

The de-multiplexer 902 may also provide PID information to an indexing control unit 908. The PID information might include, for example, a program name. The indexing control unit 908 may also receive a current buffer pointer from the memory controller 904 and may monitor the data packets being provided to the system memory buffer 906. When the indexing control unit 908 detects that an event has occurred (e.g., based on the PID or bit patterns in the data packets being provided to the system memory buffer 906), it may store the current buffer pointer value in temporary storage 910 (e.g., to facilitate creation of an index).

Consider, for example, a case where the indexing control unit 908 is to monitor the data packets to detect when a start of picture event has occurred in the encapsulated ES. In accordance with an MPEG bit stream encoding, such an event can be detected by finding the following unique sequence of bytes in the ES:
00 00 01 00
   According to some embodiments, the indexing control unit 908 may include a hardware state machine adapted to advance states in accordance with such a bit pattern. According to other embodiments, a programmable processor and associated firmware may be used to detect the occurrence of an event in the ES. Although a particular bit pattern is described herein as an example, note that other types of patterns might be detected instead.

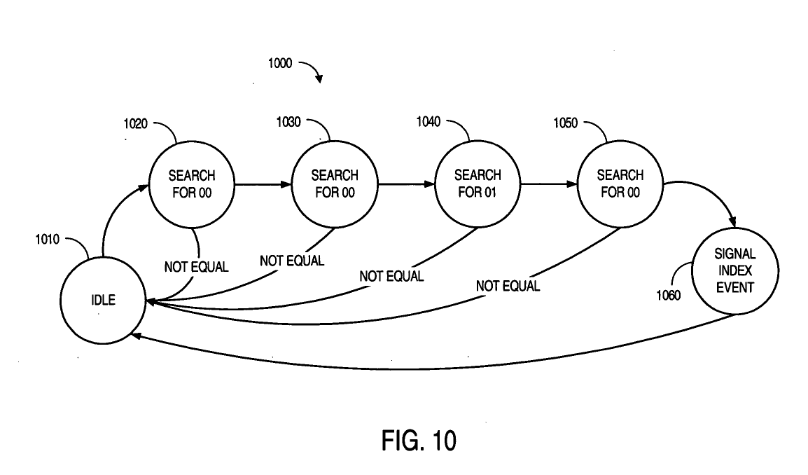

FIG. 10 illustrates event detection states 1000 according to some embodiments. The states 1000 might be associated with, for example, a hardware state machine in the indexing control unit 908 that is adapted to detect a start of picture event. Initially, the state machine is in an idle state 1010 and monitors the data packets to detect when a ES byte sequence is transferred from the memory controller 904 to the system memory buffer 906. When a byte sequence is detected, the machine advances to the next state 1020 and determines if the byte sequence was “00.” If a “00” is detected, the machine advances to the next state 1030 and monitors the data packets to detect if another byte sequence of “00” is transferred. If something other than “00” is detected while in state 1-2-, the state machine returns to the initial idle state 1010.

If another “00” is detected while in state 1030, the machine advances to the next state 1040 and now monitors the data packets to detect if a byte sequence of “01” is transferred. If something other than “01” is detected, the state machine returns to the initial idle state 1010. If a “01” is detected while in state 1040, the machine advances to the next state 1050 and now monitors the data packets to detect if a byte sequence of “00” is transferred. If something other than “00” is detected, the state machine returns to the idle state 1010.

If a “00” is detected while in state 1050, the hardware state machine has detected a byte sequence of “00 00 01 00,” and it generates a signal associated with the event index at state 1060 before returning to the idle state 1010 (e.g., to detect the next start of picture event). The generated signal might be associated with, for example, a mailbox, an interrupt, or some other notification process.

In response to the generated signal, the indexing control unit 908 may store the information in temporary storage 910. The stored information might include, for example, a current buffer pointer, event time information, event location information, and/or other information associated with the detected event.

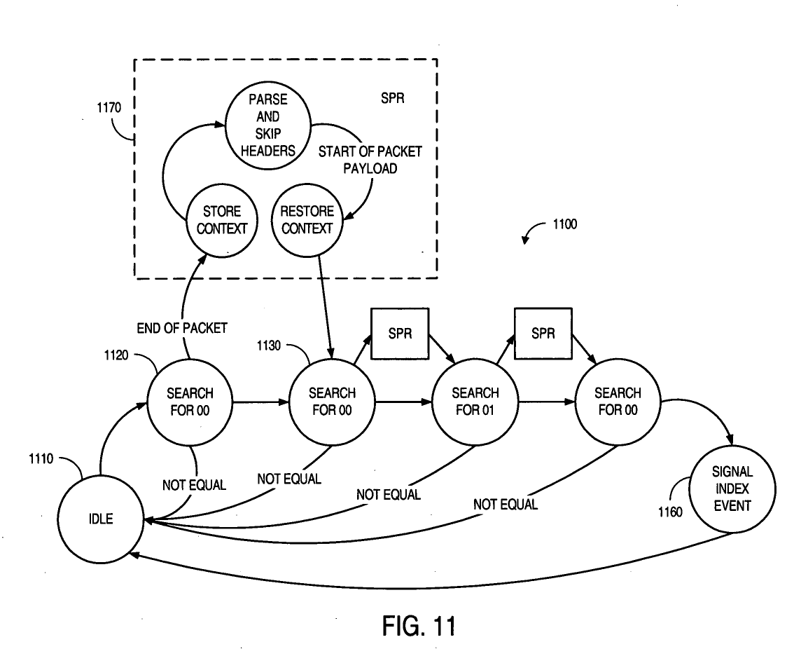

Note that in some cases, the bit sequence being detected might be encapsulated in multiple packets and therefore may not be detectable as a continuous sequence of bytes (e.g., the information might be distributed throughout a boundary if discontinuous PES or TS packets). For example, “00 00” might be encapsulated at the end of a first packet while “01 00” is encapsulated at the start of the next packet which belongs to the same PID. However, there may be a few packets that belong to other PIDs in between. FIG. 11 illustrates event detection 1100 states and a stored context according to some embodiments.

As before, the state machine is initially in an idle state 1110 and monitors data packets to detect when a byte sequence is transferred from the memory controller 904 to the system memory buffer 906. When a byte sequence is detected, the machine advances to the next state 1120 and determines if the byte sequence was “00.” If a “00” is not detected, the machine returns to the idle state 1110.

If a “00” is detected while in state 1120, the machine determines if the byte sequence occurred at the end of a packet. If the byte sequence did not occur at the end of a packet, the machine advances to the next state 1130, store the context for this stream, and will monitor the data packets until the packet from the same PID context arrives. Then, the state machine will recall the context, and will re-start its pattern search to determine if a desired pattern existed separated across the boundary of the packets.

The described “store/recall” concept allows for finding bit patterns across the boundaries of the packets, and virtually concatenates the few bytes from the tail of the preceding packet of a context with head of the next packet. The memory required for such storage might not exceed the length of the pattern of interest (four bytes in this example) per context. Moreover, it may be sufficient to avoid the need for complete demultiplexing of the stream into a separate buffer.

If the byte sequence did occur at the end of a packet, the machine advances to a Store, Parse, and Restore (SPR) process 1170. The similar approach of “store/recall” can be used, but on the next encapsulation level—now to find the patterns that may span across the boundaries of the PES packets. The storage will be associated with a different context—the PES packet context.

In particular, the context of the state machine is stored (e.g., an indication that the state machine was at state 1120 before entering the SPR process 1170). The machine will then parse data and skip PES headers that encapsulate ES information. This might be done, for example, using information in a TS header that points to a PES payload and/or information in a PES header that points to an ES payload.

When the start of the next PES packet payload for the same ES is detected, the context is restored and the machine advances to state 1130. The machine will continue detecting bit patterns (and storing context, parsing data, and restoring context between states as appropriate). If the machine reaches state 1160, the bit pattern has been detected (in a single packet or encapsulated in multiple packets), and a signal associated with the event is generated.

According to some embodiments, a hardware engine is adapted to maintain more than one context. For detecting video sequences start codes, like GOP start, this approach might include one context for PES level and one context for PID level. If other events are interpreted and used for indexing, the number of contexts may increase.

For instance, detecting Closed Caption (CC) change events and GOP start events, one needs two contexts on the PES level. If one needs detecting encryption key changes and the CC and GOP events, four contexts per stream might be required: two for PES level (one for detecting conditional access table events, one for detecting video packets) and two for PES level.

The method may be generalized to multiple streams and multiple event types Different contexts might be associated with, for example, different types of events and/or more than one ES. The complexity of implementing indexing may still be lower than that with full demultiplexing followed by indexing of the output streams.

By creating a supplemental event information file while multi-media information is recorded, a device may efficiently facilitate the presentation of the recorded information to a viewer (e.g., letting the viewer jump ahead or reverse playback a program). Moreover, when a hardware state machine (or programmable processor and associated firmware) detect events in an ES while the ES is still encapsulated in a PES and/or TS, the use of Central Processing Unit (CPU) instructions to locate an event may be reduced (and a lower-cost device may be able to efficiently locate events and facilitate a presentation of multi-media content to a viewer).

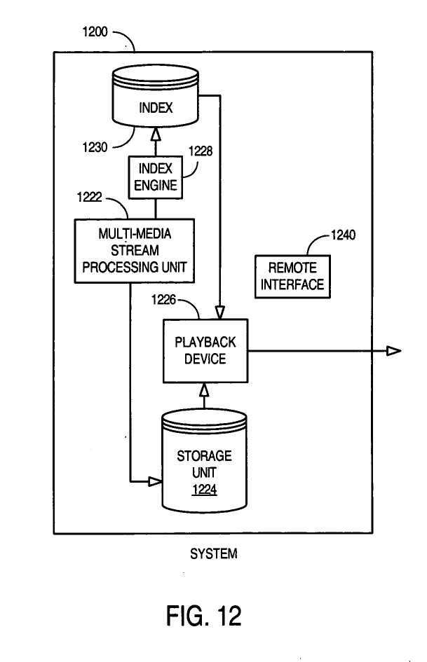

FIG. 12 is a block diagram of a system 1200 according to some embodiments. In particular, the system includes a multi-media stream processing unit 1222 processes and records multi-media information in a storage unit 1224, and a playback device 1226 may access the recorded multi-media information and generate an output signal (e.g., when playing a recorded program for a viewer).

According to some embodiments, the system 1200 further includes an indexing engine 1228 to detect and store information about an event in an ES while the ES is encapsulated in a PES. The playback device 1226 may then use the stored event information to facilitate a presentation of multi-media content to a viewer.

According to some embodiments, the system 1200 further includes a remote interface 1240 to facilitate multi-media content navigation by a viewer. The remote interface 1240 might, for example, let a user control the playback device 1226 via an Infra-Red (IR) receiver or a wireless communication network (e.g., to pause or fast-forward a television program).

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although particular types of image processes and events have been described herein, embodiments may be associated with other types of image processes and/or events. Moreover, although particular data arrangements and state machines have been described as examples, other arrangements and machines may be used.

The several embodiments described herein are solely for the purpose of illustration. Persons skilled in the art will recognize from this description other embodiments may be practiced with modifications and alterations limited only by the claims.

What is claimed is:

1. A method, comprising:
receiving a multi-media Transport Stream (TS) that encapsulates at least one Packetized Elementary Stream (PES), wherein the PES encapsulates an Elementary Stream (ES);
detecting an event occurring within the ES while the ES is encapsulated in the PES; and
storing, in an index, event information associated with the event.

2. The method of claim 1, wherein the event information is at least one of: (i) an event type, (ii) an event identifier, (iii) an event time, (iv) an event time offset, (v) an event location, (vi) an event location offset, (vii) an event disk location, (viii) an event disk location offset, (ix) an event memory location, or (x) an event memory location offset.

3. The method of claim 1, wherein the event is associated with a change in an image processing process or flow.

4. The method of claim 3, wherein the event information is associated with at least one of: (i) an image processing process identifier, (ii) a group of pictures, (iii) a group of pictures header, (iv) a frame, (v) a frame type, (vi) a frame header, (vii) a sequence, (viii) a sequence header, (ix) a slice, (x) a slice header, (xi) a quantizer scale, (xii) a motion vector, (xiii) a start of block, (xiv), a picture width, (xv) a picture height, (xvi) an aspect ratio, (xvii) a bit rate, (xviii) a picture rate, (xix) a bit pattern, (xx) a start bit pattern, or (xxi) picture entropy parameters.

5. The method of claim 1, wherein the event is associated with an encryption status.

6. The method of claim 5, wherein the event information is associated with at least one of: (i) an encryption protocol identifier, or (ii) a decryption key.

7. The method of claim 1, wherein the event is associated with media content.

8. The method of claim 7, wherein the event information is associated with at least one of: (i) a server identifier, (ii) a media content identifier, (iii) media content rating information, (iv) a program identifier, (v) a program title, (vi) a program description, or (vii) program schedule information.

9. The method of claim 1, wherein the event is associated with viewer information.

10. The method of claim 9, wherein the event information is associated with at least one of: (i) a viewer flag, (ii) a viewer preference, (iii) a viewer rule, or (iv) a viewer identifier.

11. The method of claim 1, wherein said detecting is performed by an apparatus associated with at least one of: (i) a digital display device, (ii) a television, (iii) a personal video recorder, (iv) a game device, (v) a personal computer, or (vi) a set-top box.

12. The method of claim 11, wherein the TS is delivered via at least one of: (i) a cable-based communication network, (ii) a satellite communication network, (iii) an over-the-air television broadcast, (iv) a packet-based network, (v) an Internet protocol network, or (vi) an asynchronous transfer mode network.

13. The method of claim 12, wherein the image information is associated with a Motion Picture Experts Group encoding process.

14. The method of claim 1, wherein the index is stored using at least one of: (i) a memory unit, or (ii) a disk storage unit.

15. The method of claim 1, wherein the event is detected while the PES is encapsulated in the TS.

16. The method of claim 1, further comprising:
detecting a second event occurring within the PES while the PES is encapsulated in the TS; and
storing, in the index, second event information associated with the second event.

17. The method of claim 16, wherein the second event information is associated with at least one of: (i) a decode time stamp, (ii) a presentation time stamp, (iii) a stream identifier, (iv) a packet length, (v) a PES header, or (vi) copyright information.

18. The method of claim 16, further comprising:
detecting a third event occurring within the TS; and
storing, in the index, third event information associated with the third event.

19. The method of claim 18, wherein the third event information is associated with at least one of: (i) a programme clock reference, (ii) error information, (iii) a packet identifier, (iv) scrambling information, (v) discontinuity information, (vi) priority information, (vii) splice information, or (viii) payload unit start information.

20. The method of claim 1, wherein said detecting is performed by an event hardware engine.

21. The method of claim 20, wherein the event hardware engine comprises a state machine adapted to advance states in accordance with a bit pattern.

22. The method of claim 21, wherein the event hardware engine is adapted to maintain state context when the ES is distributed throughout a discontinuous PES or a discontinuous TS.

23. The method of claim 22, wherein the event hardware engine is adapted to maintain more than one context.

24. The method of claim 1, wherein said detecting comprises:
analyzing information within the ES while the ES is encapsulated in the PES to infer the occurrence of the event.

25. The method of claim 24, wherein said analyzing includes applying heuristics to information associated with at least one motion vector or quantization coefficient to infer at least one of: (i) a scene change, (ii) a scene context, or (iii) a scene type.

26. The method of claim 1, further comprising:
recording, separate from the index, multi-media information associated with TS.

27. The method of claim 26, further comprising:
retrieving information from the index; and
using the information retrieved from the index to facilitate presentation of the recorded multi-media information to a viewer.

28. An apparatus, comprising:
an indexing control unit to receive a first stream of multi-media information that encapsulates a second stream of multi-media information; and
an index to store event information associated with an event occurring within the second stream as detected by the indexing control unit while the second stream is encapsulated in the first stream.

29. The apparatus of claim 28, further comprising:
a memory controller to provide a current buffer pointer to the index control unit, wherein at least some of the event information is based on a current buffer pointer value when the indexing control unit detects that the event has occurred.

30. The apparatus of claim 29, wherein the index control unit includes:
an event hardware state machine or a programmable processor and associated firmware adapted to advance states in accordance with a bit pattern.

31. The apparatus of claim 30, wherein the event hardware state machine or the programmable processor and associated firmware is adapted to maintain state context when the second stream is disbursed throughout the first stream along with a third stream of multi-media information encapsulated in the first stream.

32. A system, comprising:
an indexing engine to detect an occurrence of an event in an Elementary Stream (ES) while the ES is encapsulated in a Packetized Elementary Stream (PES);
an index storage unit to store information associated with the event; and
a remote interface to facilitate multi-media content navigation by a viewer.

33. The system of claim 32, wherein the indexing engine includes a hardware device or a programmable processor and associated firmware adapted to (i) advance states in accordance with a bit pattern, and (ii) maintain more that one state context, each context being associated with a different ES distributed throughout the TS.

34. The system of claim 32, wherein the ES is associated with a TS delivered via at least one of: (i) a cable-based communication network, (ii) a satellite communication network, (iii) an over-the-air television broadcast, (iv) a packet-based network, (v) an Internet protocol network, or (vi) an asynchronous transfer mode network.
